(19) United States
(12) Patent Application Publication
(10) Pub. No.: US 2006/0294355 A1
(43) Pub. Date: Dec. 28, 2006

(54) Secure variable/image storage and access

(76) Inventors: Vincent J. Zimmer, Federal Way, WA (US); Michael A. Rothman, Puyallup, WA (US); Mark Doran, Olympia, WA (US); Andrew J. Fish, Olympia, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/166,896

(22) Filed: Jun. 24, 2005

(51) Int. Cl. G06F 9/00

(52) U.S. Cl. 713/2

(57) ABSTRACT

Secure variable/image storage and access schemes for storing data in non-volatile stores. Firmware-based interfaces are provided to support secure storage of data, such as asset management data and executable images, on platforms in a manner that prevents access to any entity other than the principle that originally stored the data. In one embodiment, an extension to the Extensible Firmware Interface (EFI) variable storage scheme is disclosed. In another embodiment, a management chip that is not present on the platform is emulated by firmware such that the management chip appears to be present to entities accessing a third-party storage area of a non-volatile store.

### FIELD OF THE INVENTION

The field of invention relates generally to computer systems and, more specifically but not exclusively relates to techniques for securely storing and access runtime variables and executable images using non-volatile stores.

### BACKGROUND INFORMATION

According to the global software piracy study conducted by International Data Corporation (IDC), in 2003, 36 percent of installed software worldwide was pirated, which accounts to $29 billion in lost revenue. In the U.S. alone, 22 percent of the nation's software is unlicensed, resulting in piracy losses of more than $6.5 billion. Such findings have the BSA aggressively tracking down unlicensed software and instigating audits. Gartner Research says that 40 percent of mid to large size businesses can expect compliance audits through the year 2006. Arguably, most businesses are ethical, but many do not understand the importance of implementing an effective system of checks and balances to ensure operations throughout the enterprise are both ethical and legal.

Recent research studies concerning the use of information technology (IT) reveals about 50 percent of IT spending is on people, including internal IT payroll and external professional services. Additionally, more than 80 percent of IT spending is for the people and technology required to keep the business running, rather than for business transformation through new development and enhancements (e.g., new hardware and software). With the increasing frequency of network-wide hacking, security concerns, and virus attacks, there is more need than ever before to efficiently manage IT resources. Furthermore, to enhance security and reliability, compliance requirements have been recently codified into law, such as Sarbanes-Oxley in the United States and similar regulations in the European Union (EU) and Asia. The addition of these requirements will add significant pressure on IT staff and IT budgets.

Currently, most IT platform management for enterprises (e.g., mid to large businesses) is facilitated using “in-band” tools that support remote platform management. A typical in-band tool comprises an agent that is hosted by an operating system running on a given platform. A central management server or the like is used by IT personnel to interact with the agents running on various platforms within an enterprise to perform remote management operations such as installing software updates, detecting virus attacks, etc. In addition, a network administrator can instantly see the operating system, installed hardware and software for a given platform, and various other data, depending on the product. Organizations using remote management software have lowered their total cost of ownership and reduced the foot fatigue for network administrators, which allows them to focus on more strategic IT projects.

One common technique for managing software assets and configuration is to store corresponding information on a local mass storage device (e.g., hard disk). This may typically be performed using a shared resource (e.g., Windows Registry) or a proprietary data structure employed by a remote management tool vendor. The shared resource, while providing the advantage of being available to all users and agents, has a significant defect with respect to security, since the software asset and configuration information may be easily modified or erased. The proprietary data structure likewise has several pluses and minuses. In particular, the corresponding remote management tool may employ the registry for initially and intermittently obtaining configuration data, or the proprietary management file or files can be easily erased since they are simply stored on a local hard disk or the like.

Ideally, it would be advantageous for an operating system, software application, etc., to be able to not only manage its own resources, but also manage them in a manner that is secure. Recently, the Intel® Corporation has introduced the Intel Active Management Technology (IAMT), which employs a hardware component (i.e., chip) comprising an out-of-band (OOB) management subsystem. One of the advantages provided by IAMT is that software entities are enabled to store management data in non-volatile storage (e.g., flash chips) on-board the platform in a manner that is inaccessible to traditional attacks. While this feature is valuable, it comes at the cost of adding to the platform hardware cost. In view of the highly-competitive volume platform market and the push for the “$100” PC, it would be advantageous to provided a similar software asset/configuration management feature, but without requiring any additional hardware.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating the various execution phases that are performed in accordance with the extensible firmware interface (EFI) framework;

FIG. 2 is a block schematic diagram illustrating various components of the EFI system table that employed by embodiments of the invention during firmware variable access;

FIG. 3a is a schematic diagram illustrating a technique for producing a manifest including a digital signature used for verifying a Principle, according to one embodiment;

FIG. 3b is a schematic diagram illustrating a technique for verifying a signed manifest was sent for a Principle, according to one embodiment;

FIG. 4a is a schematic diagram of a computer system architecture under which runtime software entities (Principles) are enabled to securely store data in a non-volatile store using extensions to an EFI variable interface;

FIG. 4b is a schematic diagram of a computer system architecture under which Principles are enabled to securely store data in a serial flash chip using an emulation scheme employing similar commands to those used as if the serial flash chip was being accessed by a IAMT management chip; and

FIG. 5 is a schematic diagram illustrating data flows performed to facilitate access to the serial flash chip using the architecture of FIG. 4b.

### DETAILED DESCRIPTION

Embodiments of methods and apparatus for provide secure storage of variables and images in non-volatile stores are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In accordance with aspects of the embodiments now described, techniques are provided to support storage of software asset/configuration information and other types of management-related information, as well as executable images, in a secure manner. In addition, security extensions may be added to the techniques such that a given software/management entity may preclude all other entities from accessing its data, wherein individual secure storage “bins” may be provided for multiple software entities.

Under one embodiment, the software asset/management data/images are stored as firmware variables using extensions to traditional firmware functionality. More particular, the Extensible Firmware Interface (EFI) framework is implemented for this purpose. The EFI framework (specifications and examples of which may be found at http://developer.intel.com/technology/efi) is a public industry specification that describes an abstract programmatic interface between platform firmware and shrink-wrap operation systems or other custom application environments. The EFI framework includes provisions for extending BIOS functionality beyond that provided by the BIOS code stored in a platform's BIOS device (e.g., flash memory). EFI enables firmware, in the form of firmware modules and drivers, to be loaded from a variety of different resources, including primary and secondary flash devices, option ROMs, various persistent storage devices (e.g., hard disks, CD ROMs, etc.), and even over computer networks.

Among many features, EFI provides an abstraction for storing persistent data in the platform firmware known as “variables.” Variables are defined as key/value pairs that consist of identifying information plus attributes (the key) and arbitrary data (the value). Variables are intended for use as a means to store data that is passed between the EFI environment implemented in the platform and EFI OS loaders and other applications that run in the EFI environment, including passing variables to OS run-time entities. Although the implementation of variable storage is not defined in the EFI specification, variables must be persistent in most cases. This implies that the EFI implementation on a platform must arrange it so that variables passed in for storage are retained and available for use each time the system boots, at least until they are explicitly deleted or overwritten.

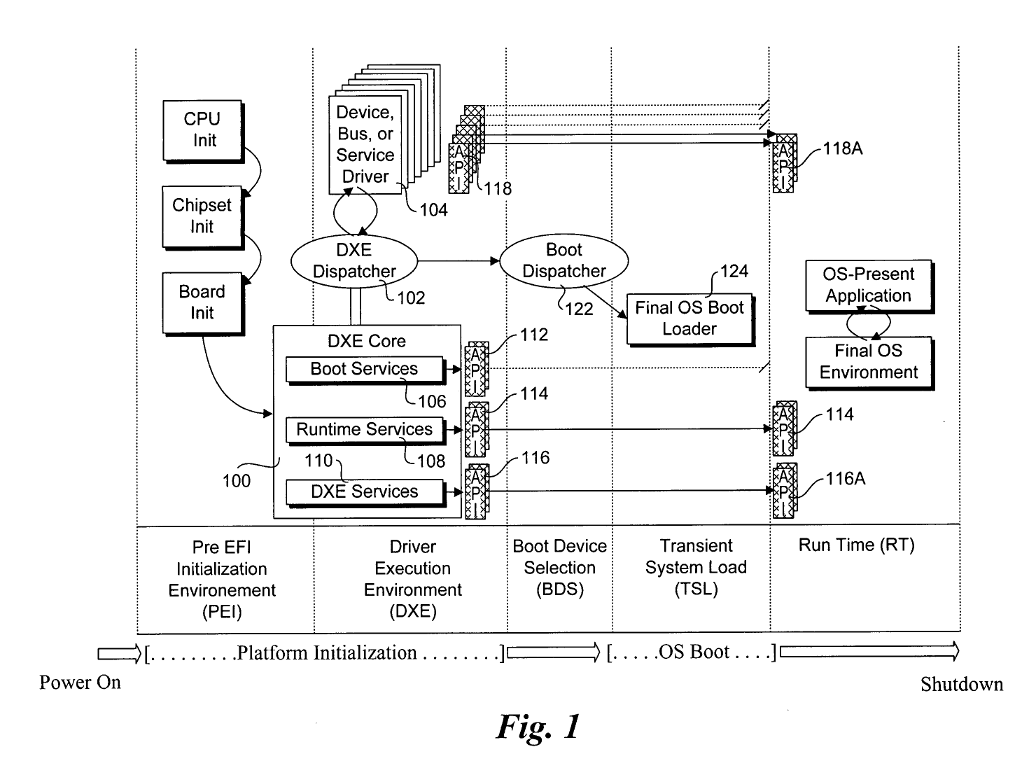

FIG. 1 shows an event sequence/architecture diagram used to illustrate operations performed by a platform under an EFI-compliant framework in response to a cold boot (e.g., a power off/on reset). The process is logically divided into several phases, including a pre-EFI Initialization Environment (PEI) phase, a Driver Execution Environment (DXE) phase, a Boot Device Selection (BDS) phase, a Transient System Load (TSL) phase, and an operating system runtime (RT) phase. The phases build upon one another to provide an appropriate run-time environment for the OS and platform.

The PEI phase provides a standardized method of loading and invoking specific initial configuration routines for the processor (CPU), chipset, and motherboard. The PEI phase is responsible for initializing enough of the system to provide a stable base for the follow on phases. Initialization of the platforms core components, including the CPU, chipset and main board (i.e., motherboard) is performed during the PEI phase. This phase is also referred to as the “early initialization” phase. Typical operations performed during this phase include the POST (power-on self test) operations, and discovery of platform resources. In particular, the PEI phase discovers memory and prepares a resource map that is handed off to the DXE phase. The state of the system at the end of the PEI phase is passed to the DXE phase through a list of position independent data structures called Hand Off Blocks (HOBs).

The DXE phase is the phase during which most of the system initialization is performed. The DXE phase is facilitated by several components, including the DXE core 100, the DXE dispatcher 102, and a set of DXE drivers 104. The DXE core 100 produces a set of Boot Services 106, Runtime Services 108, and DXE Services 110. The DXE dispatcher 102 is responsible for discovering and executing DXE drivers 104 in the correct order. The DXE drivers 104 are responsible for initializing the processor, chipset, and platform components as well as providing software abstractions for console and boot devices. These components work together to initialize the platform and provide the services required to boot an operating system. The DXE and the Boot Device Selection phases work together to establish consoles and attempt the booting of operating systems. The DXE phase is terminated when an operating system successfully begins its boot process (i.e., the BDS phase starts). Only the runtime services and selected DXE services provided by the DXE core and selected services provided by runtime DXE drivers are allowed to persist into the OS runtime environment. The result of DXE is the presentation of a fully formed EFI interface.

The DXE core is designed to be completely portable with no CPU, chipset, or platform dependencies. This is accomplished by designing in several features. First, the DXE core only depends upon the HOB list for its initial state. This means that the DXE core does not depend on any services from a previous phase, so all the prior phases can be unloaded once the HOB list is passed to the DXE core. Second, the DXE core does not contain any hard coded addresses. This means that the DXE core can be loaded anywhere in physical memory, and it can function correctly no matter where physical memory or where Firmware segments are located in the processor's physical address space. Third, the DXE core does not contain any CPU-specific, chipset specific, or platform specific information. Instead, the DXE core is abstracted from the system hardware through a set of architectural protocol interfaces. These architectural protocol interfaces are produced by DXE drivers 104, which are invoked by DXE Dispatcher 102.

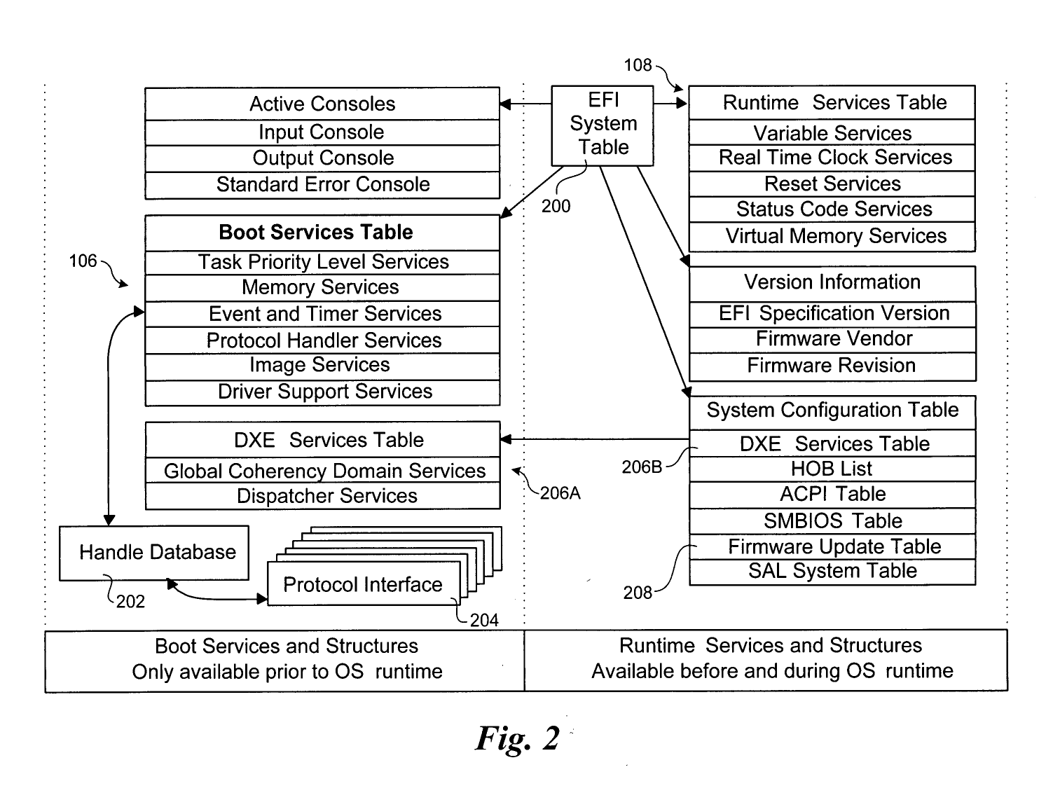

The DXE core produces an EFI System Table 200 and its associated set of Boot Services 106 and Runtime Services 108, as shown in FIG. 2. The DXE Core also maintains a handle database 202. The handle database comprises a list of one or more handles, wherein a handle is a list of one or more unique protocol GUIDs (Globally Unique Identifiers) that map to respective protocols 204. A protocol is a software abstraction for a set of services. Some protocols abstract I/O devices, and other protocols abstract a common set of system services. A protocol typically contains a set of APIs and some number of data fields. Every protocol is named by a GUID, and the DXE Core produces services that allow protocols to be registered in the handle database. As the DXE Dispatcher executes DXE drivers, additional protocols will be added to the handle database including the architectural protocols used to abstract the DXE Core from platform specific details.

The Boot Services comprise a set of services that are used during the DXE and BDS phases. Among others, these services include Memory Services, Protocol Handler Services, and Driver Support Services: Memory Services provide services to allocate and free memory pages and allocate and free the memory pool on byte boundaries. It also provides a service to retrieve a map of all the current physical memory usage in the platform. Protocol Handler Services provides services to add and remove handles from the handle database. It also provides services to add and remove protocols from the handles in the handle database. Addition services are available that allow any component to lookup handles in the handle database, and open and close protocols in the handle database. Support Services provides services to connect and disconnect drivers to devices in the platform. These services are used by the BDS phase to either connect all drivers to all devices, or to connect only the minimum number of drivers to devices required to establish the consoles and boot an operating system (i.e., for supporting a fast boot mechanism).

In contrast to Boot Services, Runtime Services are available both during pre-boot and OS runtime operations. One of the Runtime Services that is leveraged by embodiments disclosed herein is the Variable Services. As described in further detail below, the Variable Services provide services to lookup, add, and remove environmental variables from both volatile and non-volatile storage. As used herein, the Variable Services is termed “generic” since it is independent of any system component for which firmware is updated by embodiments of the invention.

The DXE Services Table includes data corresponding to a first set of DXE services 206A that are available during pre-boot only, and a second set of DXE services 206B that are available during both pre-boot and OS runtime. The pre-boot only services include Global Coherency Domain Services, which provide services to manage I/O resources, memory mapped I/O resources, and system memory resources in the platform. Also included are DXE Dispatcher Services, which provide services to manage DXE drivers that are being dispatched by the DXE dispatcher.

The services offered by each of Boot Services 106, Runtime Services 108, and DXE services 110 are accessed via respective sets of API's 112, 114, and 116. The API's provide an abstracted interface that enables subsequently loaded components to leverage selected services provided by the DXE Core.

After DXE Core 100 is initialized, control is handed to DXE Dispatcher 102. The DXE Dispatcher is responsible for loading and invoking DXE drivers found in firmware volumes, which correspond to the logical storage units from which firmware is loaded under the EFI framework. The DXE dispatcher searches for drivers in the firmware volumes described by the HOB List. As execution continues, other firmware volumes might be located. When they are, the dispatcher searches them for drivers as well.

There are two subclasses of DXE drivers. The first subclass includes DXE drivers that execute very early in the DXE phase. The execution order of these DXE drivers depends on the presence and contents of an a priori file and the evaluation of dependency expressions. These early DXE drivers will typically contain processor, chipset, and platform initialization code. These early drivers will also typically produce the architectural protocols that are required for the DXE core to produce its full complement of Boot Services and Runtime Services.

The second class of DXE drivers are those that comply with the EFI 1.10 Driver Model. These drivers do not perform any hardware initialization when they are executed by the DXE dispatcher. Instead, they register a Driver Binding Protocol interface in the handle database. The set of Driver Binding Protocols are used by the BDS phase to connect the drivers to the devices required to establish consoles and provide access to boot devices. The DXE Drivers that comply with the EFI 1.10 Driver Model ultimately provide software abstractions for console devices and boot devices when they are explicitly asked to do so.

Any DXE driver may consume the Boot Services and Runtime Services to perform their functions. However, the early DXE drivers need to be aware that not all of these services may be available when they execute because all of the architectural protocols might not have been registered yet. DXE drivers must use dependency expressions to guarantee that the services and protocol interfaces they require are available before they are executed.

The DXE drivers that comply with the EFI 1.10 Driver Model do not need to be concerned with this possibility. These drivers simply register the Driver Binding Protocol in the handle database when they are executed. This operation can be performed without the use of any architectural protocols. In connection with registration of the Driver Binding Protocols, a DXE driver may “publish” an API by using the InstallConfigurationTable function. This published drivers are depicted by API's 118. Under EFI, publication of an API exposes the API for access by other firmware components. The API's provide interfaces for the Device, Bus, or Service to which the DXE driver corresponds during their respective lifetimes.

The BDS architectural protocol executes during the BDS phase. The BDS architectural protocol locates and loads various applications that execute in the pre-boot services environment. Such applications might represent a traditional OS boot loader, or extended services that might run instead of, or prior to loading the final OS. Such extended pre-boot services might include setup configuration, extended diagnostics, flash update support, OEM value-adds, or the OS boot code. A Boot Dispatcher 120 is used during the BDS phase to enable selection of a Boot target, e.g., an OS to be booted by the system.

During the TSL phase, a final OS Boot loader 122 is run to load the selected OS. Once the OS has been loaded, there is no further need for the Boot Services 106, and for many of the services provided in connection with DXE drivers 104 via API's 118, as well as DXE Services 206A. Accordingly, these reduced sets of API's that may be accessed during OS runtime are depicted as API's 116A, and 118A in FIG. 1.

As shown in FIG. 1, the Variable Services persist into OS runtime. As such, the Variable Services API is exposed to the operating system, thereby enabling variable data to be added, modified, and deleted by operating system actions during OS runtime, in addition to firmware actions during the pre-boot operations. Typically, variable data are stored in the system's boot firmware device (BFD). In modern computer systems, BFDs will usually comprise a rewritable non-volatile memory component, such as, but not limited to, a flash device or EEPROM chip. As used herein, these devices are termed “non-volatile (NV) rewritable memory devices.” In general, NV rewritable memory devices pertain to any device that can store data in a non-volatile manner (i.e., maintain (persist) data when the computer system is not operating), and provides both read and write access to the data. Thus, all or a portion of firmware stored on an NV rewritable memory device may be updated by rewriting data to appropriate memory ranges defined for the device.

Accordingly, a portion of the BFD's (or an auxiliary firmware storage device's) memory space may be reserved for storing persistent data, including variable data. In the case of flash devices and the like, this portion of memory is referred to as “NVRAM.” NVRAM behaves in a manner similar to conventional random access memory, except that under flash storage schemes individual bits may only be toggled in one direction. As a result, the only way to reset a toggled bit is to “erase” groups of bits on a block-wise basis. In general, all or a portion of NVRAM may be used for storing variable data; this portion is referred to as the variable repository.

As discussed above, under EFI, variables are defined as key/value pairs that consist of identifying information plus attributes (the key) and arbitrary data (the value). These key/value pairs may be stored in and accessed from NVRAM via the Variable Services. There are three variable service functions: GetVariable, GetNextVariableName, and SetVariable. GetVariable returns the value of a variable. GetNextVariableName enumerates the current variable names. SetVariable sets the value of a variable. Each of the GetVariable and SetVariable functions employ five parameters: VariableName, VendorGuid (a unique identifier for the vendor), Attributes (via an attribute mask), DataSize, and Data. The Data parameter identifies a buffer (via a memory address) to write or read the data contents of the variable from. The VariableName, VendorGuid parameters enable variables corresponding to a particular system component (e.g., add-in card) to be easily identified, and enables multiple variables to be attached to the same component.

Under a database context, the variable data are stored as 2-tuples <Mi, Bi>, wherein the data bytes (B) are often associated with some attribute information/metadata (M) prior to programming the flash device. Metadata M is implementation specific. It may include information such as “deleted”, etc., in order to allow for garbage collection of the store at various times during the life of the variable repository. Under conventional usage, metadata M is not exposed through the Variable Services API but is just used internally to manage the store.

In accordance with other aspects of storage schemes disclosed herein, a trust model for secure storage is implemented based on public key infrastructure (PKI) security measures. The globally-recognized method for secure transactions is to use digital certificates to enable the encryption and digital signing of the exchanged data. The term “public key infrastructure” is used to describe the processes, policies, and standards that govern the issuance, maintenance, and revocation of the certificates, public, and private keys that the encryption and signing operations require.

Under conventional usage, public key cryptography allows users of an insecure network, like the Internet, to exchange data with confidence that it will be neither modified nor inappropriately accessed. This is accomplished through a transformation of the data according to an algorithm parameterized by a pair of numbers—the so-called public and private keys. Each participant in the exchange has such a pair of keys. They make the public key freely available to anyone wishing to communicate with them, and they keep the other key private and protected. Although the keys are mathematically related, if the cryptosystem has been designed and implemented securely, it is computationally infeasible to derive the private key from knowledge of the public key.

The nature of the relation between the public and private keys is such that a cryptographic transformation encoded with one key can only be reversed with the other. This defining feature of public key encryption technology enables confidentiality because a message encrypted with the public key of a specific recipient can only be decrypted by the holder of the matching private key (i.e., the recipient, if they have properly protected access to the private key). Even if intercepted by someone else, without the appropriate private key, this third party will be unable to decrypt the message.

The special relationship between public and private keys also enables functionality that has no parallel in symmetric cryptography; namely, authentication (ensuring that the identity of the sender can be determined by anyone) and integrity (ensuring that any alterations of the message content can be easily spotted by anyone). These features support non-repudiation (ensuring the origin or delivery of data in order to protect the sender against false denial by the recipient that the data has been received or to protect the recipient against false denial by the sender that the data has been sent) to provide electronic messages with a mechanism analogous to signatures in the paper world, that is, a digital signature.

To create a digital signature for a message, the data to be signed is transformed by an algorithm that takes as input the private key of the sender. Because a transformation determined by the sender's private key can only be undone if the reverse transform takes as a parameter the sender's public key, a recipient of the transformed data can be confident of the origin of the data (the identity of the sender). If the data can be verified using the sender's public key, then it must have been signed using the corresponding private key (to which only the sender should have access).

For signature verification to be meaningful, the verifier must have confidence that the public key does actually belong to the sender (otherwise an impostor could claim to be the sender, presenting her own public key in place of the real one). A certificate, issued by a Certification Authority, is an assertion of the validity of the binding between the certificate's subject and her public key such that other users can be confident that the public key does indeed correspond to the subject who claims it as her own.

Largely due to the performance characteristics of public-key algorithms, the entire message data is typically not itself transformed directly with the private key. Instead a small unique thumbprint of the document, called a “hash” or “digest”, is transformed. Because the hashing algorithm is very sensitive to any changes in the source document, the hash of the original allows a recipient to verify that the document was not altered (by comparing the hash that was sent to them with the hash they calculate from the document they receive). Additionally, by transforming the hash with their private key, the sender also allows the recipient to verify that it was indeed the sender that performed the transformation (because the recipient was able to use the sender's public key to “undo” the transformation). The hash of a document, transformed with the sender's private key, thereby acts as a digital signature for that document and can be transmitted openly along with the document to the recipient. The recipient verifies the signature by taking a hash of the message and inputting it to a verification algorithm along with the signature that accompanied the message and the sender's public key. If the result is successful, the recipient can be confident of both the authenticity and integrity of the message.

As used by the embodiments herein, a digital certificate serves as a cryptographic identity for various agents referred to as “Principles.” In the case of firmware, the Principles are images to be executed in the pre-boot environment, while OS runtime Principles may typically comprise runtime images from independent software vendors (ISVs). The Principles shall have access to the private key that corresponds to the public key in their certificate, and the principles may sign information, such as manifests, with the private key. In one respect, a manifest is similar to a bill-of-material for the action in question, which might include a signed has of an EFI variable, PE COFF (Pre-Installation Environment Common Object File Format) image, etc. The manifest is a type of credentials for the principal; the most important aspect of the manifest is the digital signature.

Under one implementation of the EFI variable scheme, a firmware interface is implemented as a storage manager to manage access to an underlying non-volatile storage means. This storage manager can challenge the Principles by verifying the signature in a manifest from a given Principle with the public key from the Principle's certificate in the following manner.

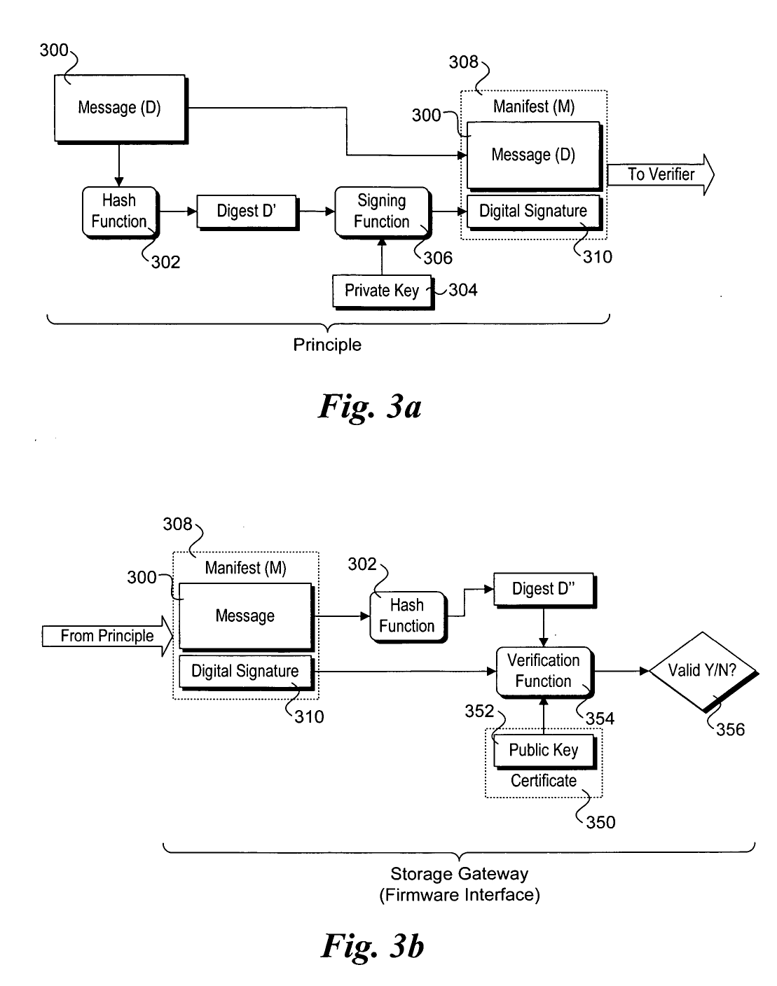

As discussed above, the Principle associated with a given certificate will hold the private key corresponding to the certificate's public key. With reference to FIG. 3a, when a Principle wishes to store data (e.g., a variable, executable image, etc.) via the storage manager, the Principle will package a set of corresponding payload data D in a message 300 in the form of bytes {B₁ . . . B_{N}}. The Principle will then compute a hash on D (message 300) using the SHA-1 (Secure Hash Algorithm) hash function 302 to generate a 20-byte hash result comprising a digest D′. The Principle then uses a private key 304 and a signing function 306 to sign the digest D′, creating the credentials in the form of a signed manifest 308 comprising the original message 300 and a digital signature 310. The Principle then invokes the EFI SetVariable command with attributes SECURE_ACCESS and *Data payload {D, M} to request storage of data D via the storage manager, which functions as a verifier 312. (In one embodiment, the SetVariable( ) interface is updated to include a new attribute field called SECURE_ACCESS, with a value of 0x0000008.)

Details of a verification process that is performed by the storage manager in response to the data storage request are shown in FIG. 3b. During some initialization/set-up phase, certificates for the Principles are provided to or otherwise made available to the storage manager, with the certificates themselves being stored somewhere on the platform. Typically, the certificates will be stored in an NV store, particularly if access is to be supported during the pre-boot. Under one embodiment, certificates for OS runtime Principles may be optionally accessed from a local mass storage device. Such certificates are exemplified in FIG. 3b by a certificate 350 including a public key 352.

The verification process proceeds as follows. First, the payload data D (message 300) is extracted from manifest 308, and the SHA-1 hash function 302 is performed on it to produce a hash result comprising a digest D″. Recall from before that this was the same way that digest D′ was formed; accordingly, digests D′ and D″ should match. A verification function 354 employing public key 352 is then performed on digital signature 310 and digest D″ to verify that the data storage request is actually from the Principle, and that the data D has not been changed since it's hashed digest D′ was digitally signed. The results of the verification function are displayed by a decision block 356. If the Principle's storage request is verified, the storage manager stores the data D in an NV store. If the storage request is not verified, storage is denied.

Other access requests, including read and update requests, proceed in a similar manner. In the case of a read request, the payload data D contains data identifying the variable, image, etc. to be read. In the case of an update request, the payload data D contains the updated data (in byte form) along with information identifying the currently-stored object to be replaced. As before, the Principle making the request is verified via its certificate (using the public key to verify the digital signature). Accordingly, any request that would be submitted from any entity other than the Principle for accessing data belonging to the Principle will be easily identified and denied.

In general, the security data may be implemented as part of the variable/image data itself, or as related data, such as metadata M discussed above. For example, extensions to the conventional EFI variable framework may be added to enable some types of security information to be provided along the data/image to be stored or information identifying the data/image to be accessed.

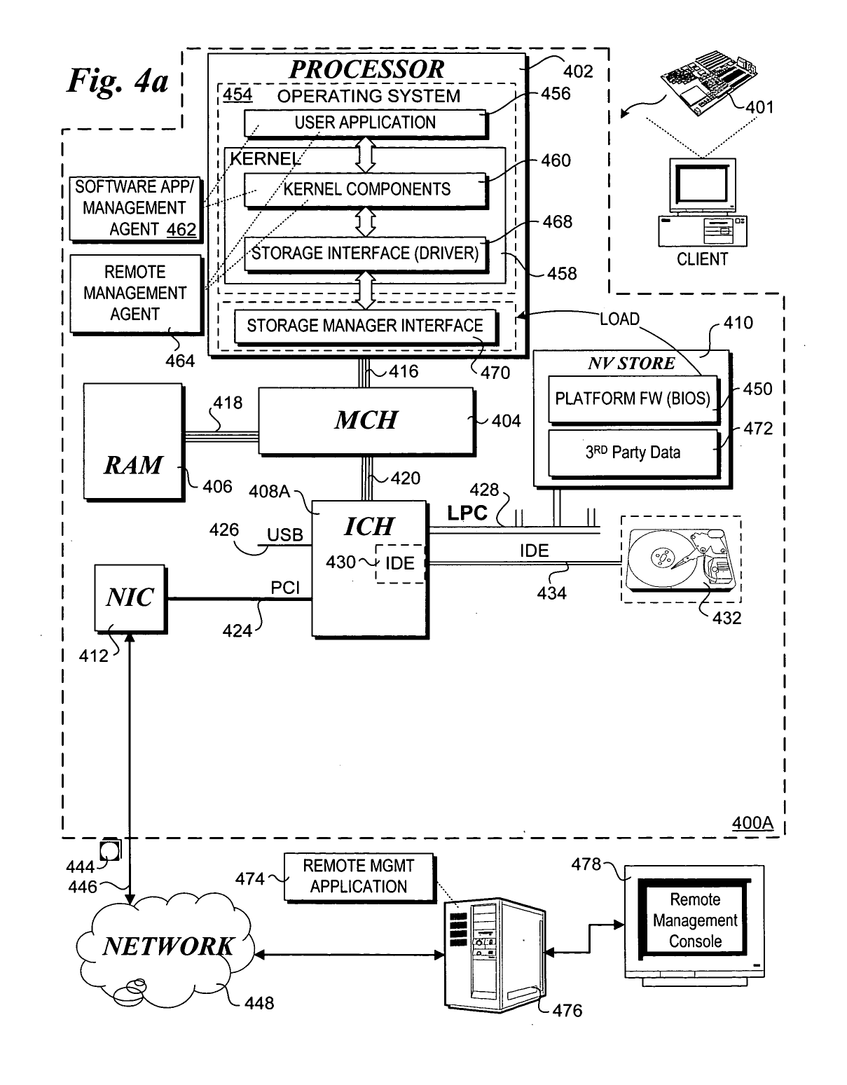

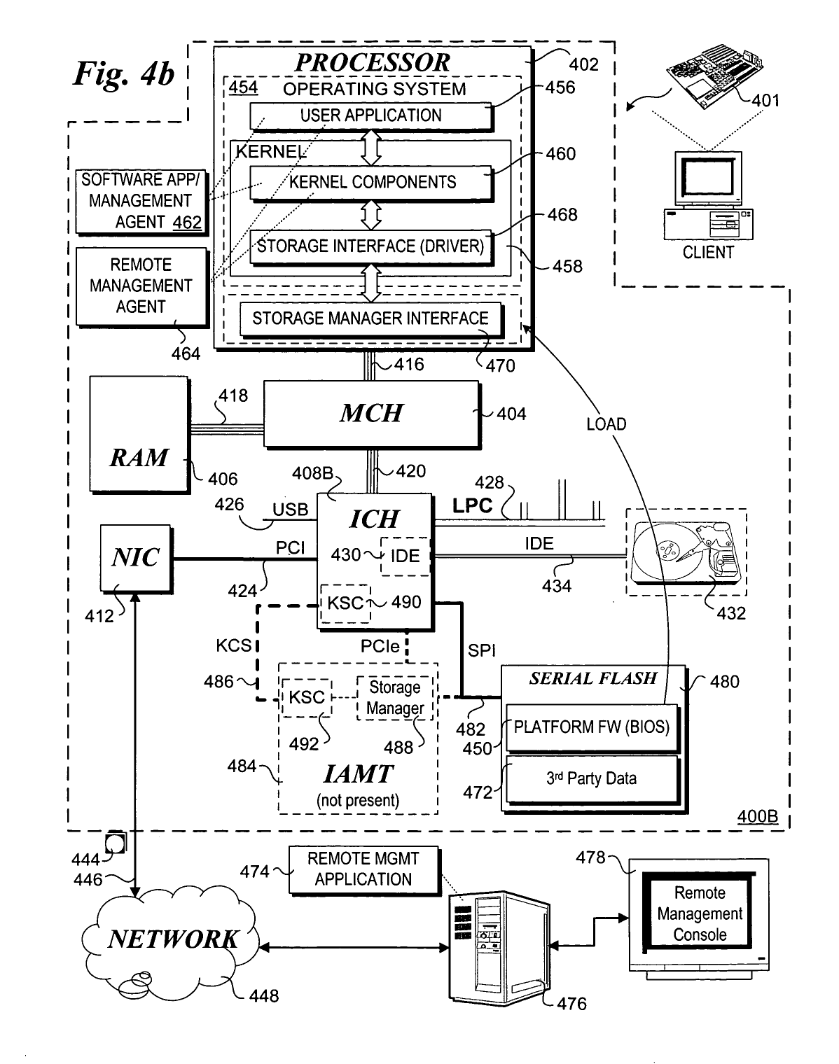

FIG. 4a shows a computer system architecture 400a (also referred to as a platform architecture) that may be used to implement aspects of one embodiment of the foregoing EFI variable secure storage scheme. The architecture includes various integrated circuit components mounted on motherboard or main system board 401. The illustrated components include a processor 402, a memory controller hub (MCH) 404, random access memory (RAM) 406, an input/output (I/O) controller hub (ICH) 408A, a non-volatile (NV) store 410, and a network interface controller 412. Processor 402 is coupled to MCH 404 via a bus 416, while MCH 404 is coupled to RAM 406 via a memory bus 418 and to ICH 408A via an I/O bus 420.

In the illustrated embodiment, ICH 408A is coupled NIC 412 via a PCI bus 424. Furthermore, various devices (not shown) in addition to NIC 412 may be connected to PCI bus 424, such as one or more PCI add-on peripheral cards, including sound cards, and video cards, for example. The ICH may also be connected to various I/O devices via corresponding interfaces and/or ports. These include a universal serial bus (USB) port 426, and a low pin count (LPC) bus 428. In one embodiment, NV store 410 is connected to ICH 408A via LPC bus 428.

In the illustrated embodiment, ICH 408A further includes an embedded integrated drive electronics (IDE) controller 430, which, in turn, is used to control one or more IDE disk drives 432 that are connected to the controller via an IDE interface 434. IDE controllers and IDE disk drives are the most common type of disk drive and controller found in modern PCs and laptop computers. Generally, in addition to the configuration shown, a separate (from ICH 408A) IDE controller may be provided for controlling an IDE disk drive.

NIC 412 supports network communications via an Ethernet port 444 over a link 446 to a network 448. In general, NIC 412 supports conventional LAN operations and protocols.

During platform initialization, various firmware components (depicted as platform firmware 450) are loaded and executed by processor 402 to prepare the platform for OS boot and set up the EFI framework. In the illustrated embodiment, platform firmware 450 is loaded via LPC bus 428, ICH 408A and MCH 404.

After the pre-boot firmware operations are complete, an operating system 454 is booted, and OS run-time operations are made available. As with a typical operating system, OS 454 includes a user-application layer in which user applications 456 are run on an OS kernel 458 that includes various kernel components 460. Generally, OS 454 will be loaded from a local mass storage device such as disk drive 432, or will be loaded from a remote storage device via network 448 (i.e., via a network boot).

In general, the secure storage schemes of the embodiments described herein may be accessed via various types of agents and applications, which in turn may be implemented at the user layer (e.g., as an application) or in the OS kernel (e.g., as a service or daemon). Accordingly, FIG. 4a shows each of a software application/management agent 462 and a remote management agent 464 being as a user application 456 or a kernel component 460.

To support interactions with NV store 410 for the purpose of third party data storage (i.e., storage employed by any software-level entity), various OS and firmware components are typically employed. These include an OS driver comprising an OS storage interface 468, and a firmware driver comprising a firmware storage manager interface 470.

Typically, devices connected to an LPC bus such as LPC bus 428 may be accessed using special processor cycles that are facilitated/managed by platform firmware 450 and/or special microcode provided by processor 402. In addition, firmware storage manager interface 470 is used to manage access to Principle data stored in third party data area 472 allocated for such storage purposes in the manner described above.

In addition to local management of software assets and the like, the scheme illustrated in each of FIGS. 4a and 4b (discussed below) support remote management via in-band facilities. The in-band facilities employed at the client include remote management agent 464, OS 454, and NIC 412. The corresponding remote management facilities include a remote management application 474 hosted by an operating system running on a remote management server 476. The user interface for the remote management operations is provided via a remote management console 478. Remote management operations are performed by remote management agent 464, which operates as a proxy for remote management application 474 using appropriate commands sent via network 448.

Under another scheme, secure third party data storage and access is implemented in a manner similar to that employed for a platform having an IAMT management chip, but such a chip is not actually present. Rather, firmware components are provided to support a virtual IAMT management chip (with respect to third party data storage aspects of IAMT) via an abstracted storage manager interface, such that a physical IAMT management chip appears to software-level entities to be present. Accordingly, the scheme emulates an IAMT management chip.

Details of an architecture 400B that may be employed to implement one embodiment of this emulation scheme are shown in FIG. 4b. The like-numbered components in each of FIGS. 4a and 4b correspond to similar components; accordingly, only the different components for architecture 400B will be discussed in detail.

As shown in FIG. 4b, an ICH 408B is connected to a serial flash chip 480 via a Serial Peripheral Interface (SPI) 482. The ICH 408B is also configured to also support communications with an IAMT management chip 484, which is not present, via SPI 482 and a PCI express (PCIe) interface. The platform firmware 450 and third party data 472 are both stored on serial flash chip 480.

Under normal practice with an IAMT management chip present, third party data storage is performed by communicating corresponding commands via a keyboard controller style (KCS) interface 486 to a storage manager 488, which in turn communicates with serial flash chip 480 via SPI 482. To support the KCS interface, each of ICH 408B and IAMT management chip 484 include KCS interface drivers 490 and 492.

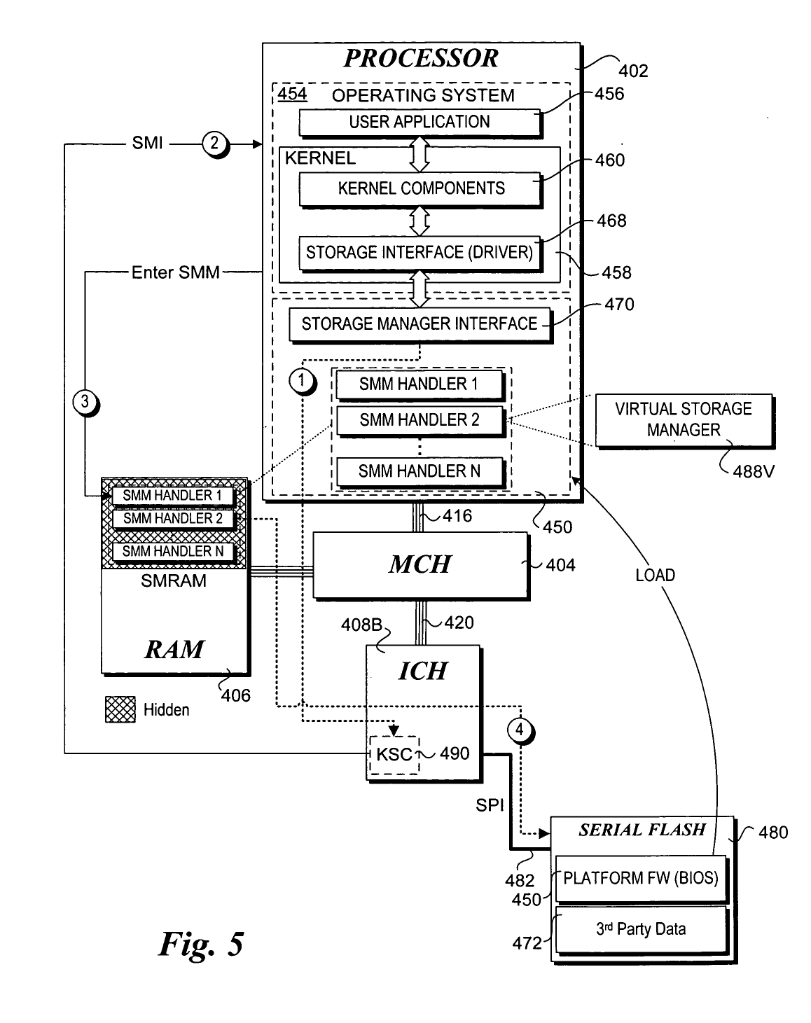

However, under architecture 400B an IAMT management chip 484 is not present. In order to manage storage and access to serial flash 480, a virtual storage manager 488V is implemented in firmware under the scheme shown in FIG. 5, wherein selected components of architecture 400B have been removed for clarity. In further detail, virtual storage manager 488V is implemented as a System Management Mode (SMM) handler that is called in response to an SMI (System Management Interrupt) event to service the event. In this instance, the SMI event corresponds to a request to access third party data 472 in serial flash chip 480.

In one embodiment, access to third party data 472 proceeds as follows, wherein corresponding operations are depicted by encircled numbers in FIG. 5. Initially, a user-layer or kernel layer agent or the like makes a request to access the third party data. In a manner similar to that described above for EFI variables, the request is passed from OS 454 to storage manager interface 470. In response to receiving the request, storage manager interface 470 performs the verification operations shown in FIG. 3b and discussed above. If the requester is not verified (e.g., the certificate public key doesn't correspond to the private key used for the digital signature), access is denied.

In one embodiment, each request is similar to that employed with an IAMT management chip (absent the additional security wrapper implemented via the secure access scheme described above). Accordingly, the request is targeted to be eventually passed to the IAMT management chip via KSC driver 490 on ICH 408B, as depicted by operation 1. However, rather than pass the request to the non-existent IAMT management chip, KSC driver 490 enunciates an SMI (operation 2), which causes processor 402 to switch to its System Management Mode to handle the corresponding SMI event (operating 3).

SMI events are handled by SMM handlers that are stored in a hidden memory space in RAM 406 known as SMRAM. This portion of RAM 406 is hidden from operating system 456 such that the OS doesn't know it even exists. (This is typically accomplished by information provided to the OS during its boot that the available memory is less than what is actually physically present, with the difference reserved for SMRAM.) Accordingly, SMRAM may not be accessed by the OS, but may only be accessed while in SMM mode.

During the pre-boot, a portion of RAM 406 is partitioned into SMRAM, and various SMM handlers are loaded from platform firmware 450 into SMRAM. The SMM handlers are executed sequentially in response to each SMI event, with a beginning portion of a given SMM handler used to determine if it is the appropriate handler for servicing the event. If not, the next SMM handler is launched and the process is repeated until the appropriate SMM handler is identified, at which point that SMM handler proceeds to completion to service the SMI event. Once the SMM event has been serviced, the processor mode is returned to it prior mode (before entering SMM), and the previous processing context is restored such that the SMM activities appear transparent to the OS.

In view of the present example, the SMI event corresponds to a request sent to a KSC port associated with KSC driver 490. Accordingly, code is provided in one of the SMM handlers (depicted as SMM HANDLER 2) to check ICH 408B to see if access to this port caused the SMI to be enunciated. Under such a condition, the remainder of the SMM handler is executed to service the KSC driver port access event.

In this instance, virtual storage manager 488V is implemented via SMM HANDLER 2. Thus, from the perspective of serial flash chip 480, it will receive a storage access command via SPI 482 that appears to have originated from storage manager 488 of an IAMT management chip (FIG. 4B). However, in reality, the storage access command is sent from ICH 408B via SPI 482, as depicted by operation 4.

In one embodiment, the aforementioned security operations performed by storage manager interface 470 may be implemented by virtual storage manager 488V. In this case the entire signed manifest will be passed along with each request sent to the KCS driver port.

In yet another embodiment, storage manager interface (or another firmware layer component not shown) “intercepts” request to the KCS driver port using a trap or the like and enunciates the SMI. Under this embodiment, no modifications to existing ICH's are required, with the functionality implemented entirely in the firmware layer.

In general, the entire data payload or manifest, as appropriate, need not be passed between components. Rather, a pointer to such data is what is passed, such that the data or manifest itself remains stored in a buffer whose location is identified by the pointer. To process the data/manifest, and instance of the data/manifest is copied from the buffer to the processing component.

As discussed throughout, various operational aspects of the embodiments described herein are performed via execution of firmware instructions on a processor. Thus, embodiments of this invention may be used as or to support a coded instructions executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and an NV store or the like (flash memory, serial flash chip, EEPROM, etc.) In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, comprising:
enabling a principle comprising a software entity to store data on and access data from a platform non-volatile store via a firmware-based storage manager;
providing a secure storage mechanism such that a given principle may only access data associated with that principle.

2. The method of claim 1, wherein the secure storage mechanism employs a public key infrastructure (PKI) verification mechanism.

3. The method of claim 2, wherein the PKI verification mechanism comprises:
digitally signing a hashed message containing a data payload with a principle's private key to form a manifest;
providing the manifest to a verifier for the storage manager;
employing a public key associated with a principle's certificate to verify the manifest came from the principle.

4. The method of claim 1, wherein the data is stored as one of an Extensible Firmware Interface (EFI) variable or PE COFF (Pre-Installation Environment Common Object File Format) image.

5. The method of claim 1, wherein the platform non-volatile store comprises a flash memory device.

6. The method of claim 1, wherein the platform non-volatile store comprises a serial flash chip.

7. The method of claim 6, further comprising:
emulating storage access features of a management subsystem that is not present on the platform but is normally employed to access the serial flash chip such that software-level commands for accessing the non-volatile store are the same as those employed to access the serial flash chip if the management subsystem was present.

8. The method of claim 7, further comprising:
employing a System Management Mode (SMM) handler to operate as a virtual storage manager to manage access to the serial flash chip.

9. The method of claim 1, further comprising:
implementing a principle comprising a remote management agent as one of a user application or kernel component in an operating system running on the platform;
receiving a data management request from a remote management entity;
using the secure storage mechanism to access data previously stored by the principle from the non-volatile store; and
returning the data to the remote management entity.

10. A machine-readable medium, to store firmware instructions that if executed by a platform processor perform operations comprising:
enabling a principle comprising a software entity to store data on and access data from a non-volatile store on the platform; and
providing a secure storage mechanism such that a given principle may only access data associated with that principle.

11. The machine-readable medium of claim 10, wherein the secure storage mechanism employs a public key infrastructure (PKI) verification mechanism using operations including:
digitally signing a hashed message containing a data payload with a principle's private key to form a manifest;
providing the manifest to a verifier for a storage manager;
employing a public key associated with a principle's certificate to verify the manifest came from the principle.

12. The machine-readable medium of claim 10, wherein the data is stored as one of an Extensible Firmware Interface (EFI) variable or PE COFF (Pre-Installation Environment Common Object File Format) image.

13. The machine-readable medium of claim 10, wherein execution of the firmware instructions performs further operations comprising:
emulating storage access features of a management subsystem that is not present on the platform but is normally employed to access a serial flash chip comprising the non-volatile store such that software-level commands for accessing the non-volatile store are the same as those employed to access the serial flash chip if the management subsystem was present.

14. The machine-readable medium of claim 13, wherein a portion of the firmware instructions are embodied as a System Management Mode (SMM) handler that operates as a virtual storage manager to manage access to the serial flash chip when executed.

15. A computer system, comprising:
a processor;
a memory, operatively coupled to the processor via a memory controller hub;
an input/output controller hub (ICH), operatively coupled to the processor via the MCH; and
a flash memory device, operatively coupled to the processor via the ICH and MCH, having firmware instructions stored therein to be executed by the processor to perform operations including,
implementing an Extensible Firmware Interface (EFI) framework including an storage manager interface to store EFI variables in the flash memory device;
enabling a principle comprising a software entity to be run on the processor to store data on and access data from the flash memory via a storage manager interface; and
implementing a secure storage mechanism such that a given principle may only access data stored on the flash memory device that is associated with that principle.

16. The computer system of claim 15, wherein the secure storage mechanism employs a public key infrastructure (PKI) verification mechanism using operations including:
digitally signing a hashed message containing a data payload with a principle's private key to form a manifest;
providing the manifest to a verifier for a storage manager;
employing a public key associated with a principle's certificate to verify the manifest came from the principle.

17. The computer system of claim 15, wherein the flash memory chip is coupled to the ICH via a low pin count (LPC) bus.

18. A computer system, comprising:
a processor;
a memory, operatively coupled to the processor via a memory controller hub;
an input/output controller hub (ICH), operatively coupled to the processor via the MCH; and
a serial flash chip, coupled to the ICH via a Serial Peripheral Interface (SPI), having firmware instructions stored therein to be executed by the processor to perform operations including,
emulating storage access features of a management subsystem that is not present on the computer system but is normally employed to access a third party storage area on the serial flash chip such that software-level commands for accessing the third party storage area are the same as those employed to access the third party storage area if the management subsystem was present; and
enabling a principle comprising a software entity to be run on the processor to store data on and access data from the third party storage area of the serial flash chip via the emulated storage access features.

19. The computer system of claim 18, wherein execution of the firmware instructions performs further operations, including:
implementing a secure storage mechanism such that a given principle may only access data stored on the third party storage area of the flash memory device that is associated with that principle.

20. The computer system of claim 18, wherein access to the third party data area is facilitated by operations comprising:
receiving an access request targeted for a KCS (keyboard controller style) port on the ICH;
enunciating a System Management Interrupt (SMI) in response thereto;
switching the processor to a System Management Mode (SMM);
executing an SMM handler operating as a virtual storage manager to manage access to the third party data store; and
switching the processor back to a previous processing context prior to entering the SMM.
